(19) United States
(12) Patent Application Publication
(10) Pub. No.: US 2008/0272110 A1
(43) Pub. Date: Nov. 6, 2008

(54) Electric heating apparatus and pipe lining method using same

(75) Inventors: Takao Kamiyama, Hiratsuka-shi (JP); Guochun Xu, Hiratsuka-shi (JP); Kazuki Shimizu, Hiratsuka-shi (JP); Takashi Ookubo, Hiratsuka-shi (JP); Youshitaka Arii, Tokyo (JP)

Correspondence Address: BRUCE L. ADAMS, ESQ.;ADAMS & WILKS, SUITE 1231, 17 BATTERY PLACE, New York, NY, 10004, US

(73) Assignee: SHONAN GOSEI-JUSHI SEISAKUSHO K.K.

(21) Appl. No.: 12/079,491

(22) Filed: Mar. 27, 2008

(30) Foreign Application Priority Data
Mar. 28, 2007 (JP) 2007-084009

(51) Int. Cl. H05B 3/58; F16L 55/16

(52) U.S. Cl. 219/535; 138/98

(57) ABSTRACT

An electric heating apparatus comprises a sheet heating element having two end electrodes and a center electrode. The sheet heating element is wound around the external peripheral surface of an airtight and elastic expandable balloon. The balloon is disposed inside a lining material impregnated with a thermosetting resin for repairing a pipe and is swelled against the inside wall of the pipe through the lining material. The end and center electrodes are supplied with electricity to generate heat in the sheet heating element, thereby curing the thermosetting resin impregnated in the lining material. This allows pipe lining to be performed with much higher energy efficiency and simpler steps.

### BACKGROUND OF THE INVENTION

1. Field of the Invention

The present invention relates to an electric heating apparatus for heating and curing a thermosetting resin impregnated into a pipe lining material, and to a pipe lining method for lining pipes by using this electric heating apparatus.

2. Description of the Prior Art

When underground sewerage pipes and the like become aged, a pipe repair method is performed wherein the inside surfaces of the pipes are lined and the pipes are repaired. Specifically, a lining material impregnated with a thermosetting resin is inserted into the pipes and cured by the infusion of steam, hot water, or another such heating medium, thereby forming lined pipes of strong fiber-reinforced plastic.

A material impregnated with a thermosetting resin is indirectly heated through heat exchange with a heating medium, and numerous machines such as boilers, pumps, water supply trucks, or the like are therefore needed. If these machines do not operate well, problems of poor energy efficiency are encountered, and energy is required to heat large amounts of the heating medium.

Electrical heating methods have been proposed to increase operating efficiency in conventional lining methods. For example, Japanese Laid-open Patent Publication No. 1990-155719 discloses an electrically conductive lining material comprising an electrically conductive belt-shaped resin-absorbing material having a conductor that has greater electrical conductivity than the resin-absorbing material. The resin-absorbing material is formed into a pipe shape with both ends insulated, and is then impregnated with a thermosetting resin.

The electrically conductive resin-absorbing layer proposed in Japanese Laid-open Patent Publication No. 1990-155719 is composed of a polyester nonwoven fabric blended with carbon fibers and has strong electrical resistance, causing increased voltage to be applied between conductors. Therefore, this layer has problems in that operators may receive electric shocks in humid environments, such as is the case with sewerage pipes.

To reduce the applied voltage, it has been proposed that a plain weave carbon fabric sheet be used in place of the nonwoven fabric blended with carbon fibers. For example, Japanese Laid-open Patent Publication No. 1998-166446 discloses a lining material formed from a double-layered structure of an electrically conductive plain weave carbon fabric sheet and a nonconductive felt sheet. In this lining material, the layers are glued together in different levels, metal electrodes are temporarily joined parallel to each other, and the material is wound around a packer. The material is then moved to a damaged part, subjected to pressure to expand in diameter, and is electrically energized to cure the thermosetting resin.

However, in conventional practice, when a metal conductor such as a copper wire, a copper band, or an aluminum band is merely pressed into an electrically conductive sheet such as conductive felt or a plain weave carbon sheet, the surface area of contact between the two is limited, and the contact resistance varies with the pressure. Therefore, a problem is encountered in that it is difficult to ensure uniformity of heat generation.

Another problem of the prior art is that since the electrodes composed of metal conductors are parallel and near to each other, there is a danger of short-circuiting unless sufficient insulation distance is provided.

Yet another problem of the prior art is that during the steps of manufacturing and inserting the lining material, the penetration of resin or solvent into the heating element, the electrodes, and the connection terminals increases resistance and causes physical damage and other such problems.

Therefore, an object of the present invention is to provide an electric heating apparatus that can effectively produce heat in order to heat and cure a thermosetting resin without the danger of short-circuiting, and to provide a pipe lining method in which this electric heating apparatus is used to line pipes.

### SUMMARY OF THE INVENTION

An electric heating apparatus according to the present invention comprises a sheet heating element having end electrodes provided at the ends of the element and oriented parallel to each other, a center electrode provided in a central part between the end electrodes and oriented parallel to the end electrodes, and a plurality of heating threads disposed at specific intervals in a direction that intersects the end electrodes and center electrodes. The end and center electrodes are woven into a fabric. The sheet heating element is wound around the external peripheral surface of an airtight and elastic expandable balloon. The end and center electrode are electrically energized to produce heat in the heating threads.

When the sheet heating element is shaped into a cylinder, short-circuiting in the electrodes can be prevented even when the end electrodes overlap each other or are in proximity to each other because the same electric potential is applied to the end electrodes.

In the present invention, the electrodes are configured so that multiple electrode threads are woven in a honeycomb pattern and are extended in the length direction. Weaving together insulating threads, heating threads having greater resistance than electrode threads, and longitudinal threads disposed at specific intervals causes the electrodes and the heating element to adhere together and makes it possible to reduce contact resistance.

In the present invention, the sheet heating element is wound around the external peripheral surface of a bag-shaped balloon that is airtight, heat-retentive, and elastic. This provides an electric heating balloon. The balloon can be expanded and swelled by any type of fluid pressure, and the thermosetting resin impregnated in the lining material can be heated in an energy-efficient manner.

Furthermore, in the present invention, a lining material impregnated with a thermosetting resin and the electric heating balloon of the present invention are inserted into an aged pipe and secured against the aged pipe by means of fluid pressure, and electric power is supplied to cure the thermosetting resin, thus lining the pipe. Since the steps of manufacturing the lining material are independent of the steps of manufacturing the electric heating balloon, there are no adverse effects on the heating element, the electrodes, or the contact terminals.

In the present invention, three electrodes are provided to the sheet heating element, and voltage can be applied between the center electrode and the end electrodes while the same electric potential is maintained between the end electrodes. Therefore, short-circuiting in the electrodes can be prevented even when the end electrodes overlap (come into contact with) each other or are in proximity to each other. When an electric heating balloon having this new mechanism is used, safe construction with no danger of electrical short-circuiting is made possible.

The method of lining aged pipes with the use of the electric heating balloon of the present invention requires a much smaller thermal capacity than commonly used indirect heating methods that use hot water, steam, or the like, and therefore has much higher energy efficiency. There is also no need for a water supply truck, a boiler, a circulation pump, or the like, and the machinery is compact, allowing for a simple lining process.

Further features of the invention, its nature and various advantages will be more apparent from the accompanying drawings and following detailed description of the invention.

### BRIEF DESCRIPTION OF THE DRAWINGS

FIG. 1 is a partially broken plan view schematically showing a sheet heating element used in the present invention;

FIG. 2 is an illustrative view schematically showing the manner in which the various threads of the sheet heating element are woven;

FIG. 3 is an illustrative view showing the electrode threads woven in a honeycomb pattern into the sheet heating element;

FIG. 4 is a perspective view of an electric heating balloon wherein the sheet heating element of the present invention is wound in the shape of a cylinder around a balloon;

FIG. 5 is a perspective view of an electric heating balloon wherein the sheet heating element of the present invention is wound in a spiral pattern around a balloon; and

FIG. 6 is an illustrative view showing a lining method for repairing a pipe by using the electric heating balloon.

### DESCRIPTION OF THE PREFERRED EMBODIMENTS

The present invention will be described in detail with reference to the attached drawings. The present invention can be modified to various other forms, and the embodiments presented herein should not be interpreted to be limiting of the scope of the present invention. The shapes and other features of elements in the drawings are exaggerated so as to provide a clearer description, and should not be interpreted to be limiting of the design or dimensions of elements of the present invention.

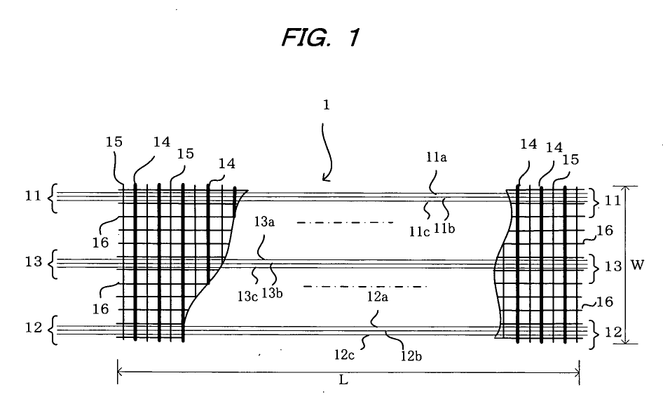

FIG. 1 schematically shows a sheet heating element 1. In this sheet heating element 1, electrodes 11, 12 extending longitudinally (in the length direction) are provided in parallel at the two laterally oriented end portions as seen in the drawing, and a center electrode 13 extending parallel to these end electrodes 11, 12 is provided in the middle of the electrodes 11, 12. The sheet heating element 1 is in the form of a fabric, woven from longitudinally extending insulating threads 16, laterally extending electric heating threads 14 depicted by bold, solid lines that intersect the insulating threads 16 and the electrodes 11, 12, 13, and laterally extending insulating threads 15 for insulating the heating threads 14.

To make it easier to understand the sheet heating element 1, a plain weave fabric is depicted, but a sateen weave, a twill fabric, a mock leno weave, a binding weave, a warp weave, or the like can also be used.

The electrodes 11, 12, 13 are composed of one or more electrode threads, and are preferably composed of two to twenty threads. In FIG. 1, the electrodes 11, 12, 13 are configured from three electrode threads 11a to 11c, 12a to 12c, and 13a to 13c, respectively. The fewer the number of electrode threads in the electrodes 11, 12, 13, the smaller the area of contact with the heating threads, and therefore the greater the contact resistance and the more limited the electric capacity of the electrodes. Having a large number of electrode threads resolves these problems but also increases the percentage of surface area that does not produce heat. The number of each of the electrodes 11, 12, 13 does not need to be the same, and it is preferable that the number of electrode threads in the center electrode 13 be twice the number of electrode threads in the end electrodes 11, 12.

The material of the electrode threads is not limited, but the threads are preferably composed of metal, a metal compound, an electrically conductive polymer, electrically conductive carbon fibers, or a composite thereof. The lower the electrical resistance, the better, and the electrical resistance is preferably kept at 5 Ω/cm or less.

The heating threads 14 are composed of electrically conductive threads having higher electrical resistance than the electrode threads, and the electrical resistance of the heating threads is preferably 500 times or more the electrical resistance of the electrode threads.

The material of the heating threads 14 is not limited, but the threads are preferably composed of metal, a metal compound, an electrically conductive polymer, electrically conductive carbon fibers, or a composite thereof; or the threads are preferably nonconductive threads coated with an electrically conductive substance.

The laterally extending insulating threads 15 and the longitudinally extending insulating threads 16 are composed of synthetic fibers, natural fibers, or ceramic fibers.

The number of heating threads 14 and insulating threads 15 as well as the arrangement of the threads 14, 15 can be designed according to the heating capacity of the heating element. For example, a number of heating threads 14 calculated from the capacity of the heating element is disposed at equal intervals, and an insulating thread 15 is placed between every two adjacent heating threads 14. The numbers of heating threads 14 and insulating threads 15 are calculated from the thickness of the insulating threads 15 and the distance needed to insulate the heating threads 14.

The number of insulating threads 16 extending in the length direction can be calculated from the thickness of the insulating threads 16 and the distance between the electrodes, which is calculated from the heating capacity of the heating element 1. The center electrode 13 is preferably disposed substantially in the middle between the end electrodes 11, 12.

In FIG. 1, only parts of the heating threads 14 and the insulating threads 15, 16 are shown for the sake of simplicity, but these threads are provided across the entire surface of the heating element in the depicted arrangement.

In FIG. 1, the heating threads 14 and the insulating threads 15, 16 are exposed bare, but an insulating covering layer that covers the entire surfaces of all these threads 14, 15, 16 may also be provided on the front surfaces, the back surfaces, or both surfaces.

In FIG. 1, the sheet heating element 1 is specifically made from a plain weave in which the laterally extending heating threads 14 and insulating threads 15 alternate in parallel at uniform intervals, constituting lateral threads; and the longitudinally extending insulating threads 16 are parallel to the electrode threads 11a to 11c, 12a to 12c, and 13a to 13c of the electrodes 11, 12, 13, constituting longitudinal threads. The insulating threads 15, 16 are made of polyester fibers, and the heating threads 14 are electrically conductive threads composed of polyester fibers covered with electrically conductive carbon. The electrode threads 11a to 11c, 12a to 12c, and 13a to 13c are composed of copper wire covered with tin.

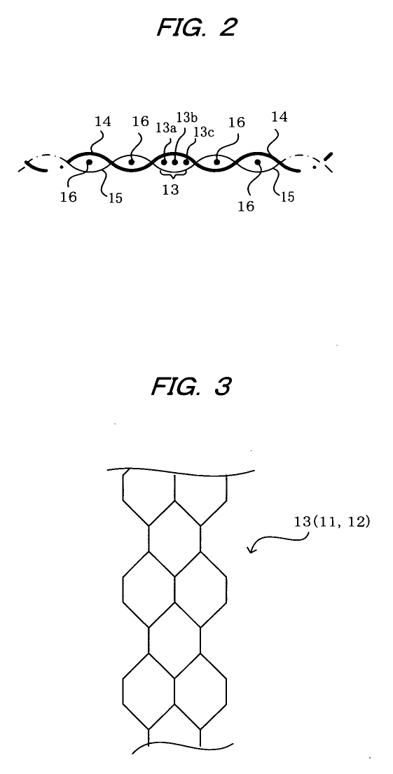

FIG. 2 is a schematic depiction, as seen from the side, of the arrangement of threads in the plain weave sheet heating element 1 in the vicinity of the center electrode 13.

The electrode threads 11a to 11c, 12a to 12c, and 13a to 13c of the electrodes 11, 12, 13 do not need to be merely arranged tightly together in parallel as shown in FIG. 1, but can also be configured from multiple (three) electrode threads woven together in a honeycomb pattern, as shown in FIG. 3. In FIG. 3, the longitudinal direction of FIG. 1 is shown as the lateral direction, and the electrode threads 13 are shown as a representation, but the other electrode threads 11, 12 are also woven in the same honeycomb pattern.

Weaving multiple electrode threads together in a honeycomb pattern in this manner improves adhesion between the electrodes and the heating threads and makes it possible to reduce contact resistance.

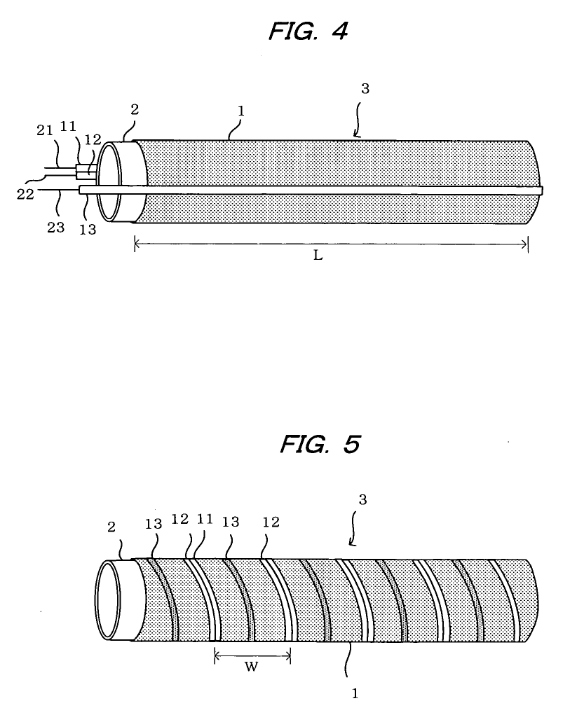

FIG. 4 is a schematic depiction of an electric heating balloon 3, in which a sheet heating element 1 of length L is wound around a cylindrical balloon 2. FIG. 4 shows a state in which the length direction (longitudinal direction) of the sheet heating element 1 is parallel to the axial direction of the balloon 2, the sheet heating element 1 is wound around the balloon 2, and the end electrodes 11, 12 are in contact with each other or are in proximity to each other. The end electrodes 11, 12 and the center electrode 13 extend parallel to each other in the length direction as shown in FIG. 4, and, assuming that the cross section of the balloon 2 is a circle, the end electrodes 11, 12 are positioned facing radially inward towards the center electrode 13.

FIG. 4 shows an image of one wound sheet heating element 1, but multiple sheet heating elements 1 can also be wound around the balloon 2 to add to the diameter.

FIG. 5 shows an electric heating balloon 3 wherein the sheet heating element 1 is wound around the circumferential surface of the balloon 2 in a spiral pattern at a specific pitch. The sheet heating element 1 is wound in a spiral pattern so that the end electrode 11 is in proximity to or in contact with the other end electrode 12. In cases in which the sheet heating element 1 is wound around the balloon 2 in the shape of a cylinder as shown in FIG. 4, the width W and length L of the sheet heating element 1 must be set in accordance with the diameter and length of the balloon, but in cases in which the sheet heating element is wound in a spiral pattern as shown in FIG. 5, the sheet heating element 1 can be wound around a balloon of any diameter and length without changing the width W and length L of the sheet heating element.

The balloon 2 expands due to fluid pressure and has the role of pushing the heating element 1 out against the inside wall of the pipe when the inside surface of the aged pipe is being repaired using the lining material. Therefore, the balloon is preferably made of an airtight and elastic material. The material is not particularly limited, but is preferably rubber, a woven or nonwoven fabric, a plastic thin film, or a layered product thereof.

In specific terms, the electric heating balloon 3 shown in FIGS. 4 and 5 is depicted as being configured from a sheet heating element 1 wound around a balloon 2. The balloon is composed of polyester felt that covers a polyethylene-nylon composite film. Another coating, though not depicted, is further applied. The two end electrodes 11, 12 of the sheet heating element are adjacent to each other, and lead wires 21, 22 connected to the electrodes 11, 12 can be short circuited to maintain the same electric potential. A lead wire 23 is independently connected to the center electrode 13.

The covered polyethylene-nylon film is fused by heat at the ends of the electric heating balloon 3, providing airtightness. A connecting belt is also attached.

Although this is not shown, the balloon 2 has an opening for injecting a fluid to expand the balloon, and an opening to discharge the fluid.

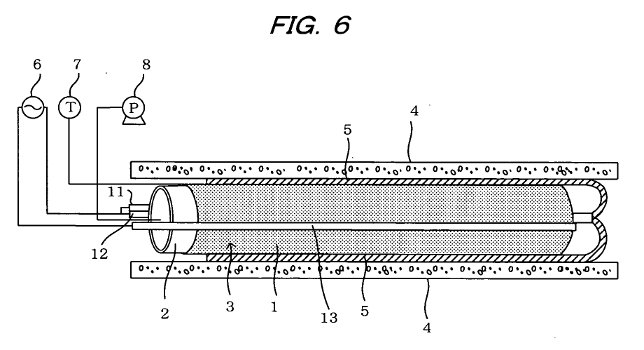

FIG. 6 is a diagram schematically depicting the manner in which a pipe is repaired using the electric heating balloon 3 of the present invention. A lining material 5 and the electric heating balloon 3 are inserted into an aged pipe 4, and a pressure pump 8 is used to expand the electric heating balloon 3 and push the lining material 5 up against the inside wall of the pipe 4. Electric power is then supplied from a power source 6 to generate heat in the electric heating balloon 3, and the thermosetting resin impregnated in the lining material 5 is cured, forming a liner pipe provided with a sturdy inner lining. A temperature sensor 7 for sensing the temperature of the fluid in the electric heating balloon is provided in FIG. 6. Although not shown in FIG. 6, a pressure sensor or the like is also provided for sensing the pressure of the fluid.

The lining material 5 and the electric heating balloon 3 can be inserted into the aged pipe 4 by everting the lining material 5 while drawing the electric heating balloon 3 connected at the ends of the lining material 5 into the aged pipe 4, or by drawing the lining material 5 and the electric heating balloon 3 into the aged pipe 4 together.

The pressure pump 8 is a device for applying air pressure, gas pressure, or water pressure, and possible examples include an air compressor, a gas cylinder, a water pump, and the like.

The power source 6 is a device for supplying electric power, and possible examples include an electric power generator, a commercial power source, a battery, and the like.

The thermosetting resin impregnated in the lining material 5 is configured from an unsaturated polyester resin, vinyl ester resin, or epoxy resin compound, wherein the primary additives are a filler composed of aluminum hydroxide, silica, talc, calcium carbonate, or the like; and a curing agent that generates radicals when thermally decomposed.

The lining material 5 is a liner composed of polyester felt that is covered with a polyethylene-nylon composite film having a connecting belt attached at the ends. The liner is impregnated with a compound of an unsaturated polyester resin in which a curing agent and a filler are evenly distributed. The lining material is designed in accordance with the nominal diameter and length of the aged pipe, and the design strength of the liner pipe.

With this configuration, the pipe is repaired in the following manner.

First, the lining material 5 and the electric heating balloon 3 are joined together and placed in an everting machine (not shown). The starting end of the lining material 5 is attached to an everting nozzle, the lining material 5 is everted within the pipe 4 by air pressure, and the electric heating balloon 3 is then drawn into the lining material 5.

A collar having an air inlet and a temperature sensor 7 is attached to the starting end of the electric heating balloon, and the power source cord and lead wires of the electrodes 11, 12, 13 are connected to the power source 6.

The pressure pump 8 is operated to pump compressed air into the pipe 4, causing the electric heating balloon 3 to expand and the sheet heating element 1 to adhere to the lining material 5, and the lining material 5 is pushed up against the inside wall of the pipe 4. At this time, the air pressure is calculated from the thickness of the lining material 5 and the hydraulic head pressure of the influent water.

Next, electric power is supplied to the electric heating balloon 3, causing the sheet heating element 1 to produce heat and cure the thermosetting resin impregnated in the lining material 5. The temperature sensor 7 tracks changes in the interfacial temperature and adjusts the supply of electric power and the duration of application according to the existing conditions.

What is claimed is:

1. An electric heating apparatus, comprising a sheet heating element in which three electrodes are woven in parallel, the element being wound around an airtight and elastic balloon.

2. An electric heating apparatus according to claim 1, wherein the sheet heating element is wound in a cylindrical shape around the external peripheral surface of the balloon.

3. An electric heating apparatus according to claim 1, wherein the sheet heating element is wound in a spiral pattern at a prescribed pitch around the external peripheral surface of the balloon.

4. An electric heating apparatus, comprising:
a sheet heating element having parallel end electrodes, a center electrode provided parallel thereto in a central part thereof, and a plurality of fabric-woven heating threads disposed at predetermined intervals in a direction that intersects the end and center electrodes,
wherein the element is wound around the external peripheral surface of an airtight and elastic expandable balloon, and the center and end electrodes are electrically energized, thereby supplying the heating threads with electricity to generate heat in the heating threads.

5. An electric heating apparatus according to claim 4, wherein the sheet heating element is wound in a cylindrical shape around the external peripheral surface of the balloon so that the end electrodes are in contact with each other or are in proximity to each other and the end electrodes are positioned facing radially inward towards the center electrode.

6. An electric heating apparatus according to claim 4, wherein the sheet heating element is wound in a spiral pattern at a prescribed pitch around the external peripheral surface of the balloon.

7. An electric heating apparatus according to claim 4, wherein insulating threads for insulating the heating threads are woven in between the heating threads.

8. An electric heating apparatus according to claim 4, wherein a plurality of insulating threads is woven in a direction that intersects the heating threads.

9. An electric heating apparatus according to claim 4, wherein the end and center electrode are woven in a honeycomb pattern.

10. A pipe lining method, comprising the steps of:
preparing a sheet heating element having parallel end electrodes, a center electrode provided parallel thereto in a central part thereof, and a plurality of fabric-woven heating threads disposed at predetermined intervals in a direction that intersects the end and center electrodes, the element being wound around the external peripheral surface of an airtight and elastic expandable balloon;
disposing the balloon inside a lining material impregnated with a thermosetting resin for repairing a pipe;
swelling and pressing the balloon against the inside wall of the pipe through the lining material;
supplying the end and center electrodes with electricity to generate heat in the sheet heating element wound around the balloon, thereby curing the thermosetting resin impregnated in the lining material and line the pipe.
